(19) United States
(12) Patent Application Publication
(10) Pub. No.: US 2024/0354848 A1
(43) Pub. Date: Oct. 24, 2024

(54) Rating System for Comparative Analysis of Tradable Securities and Method Thereof

(71) Applicant: Sundeep Nallamilli, Rajahmundry (IN)

(72) Inventor: Sundeep Nallamilli, Rajahmundry (IN)

(21) Appl. No.: 18/251,162

(22) PCT Filed: Feb. 11, 2022
(86) PCT No.: PCT/IN2022/050119

§ 371 Date: Apr. 28, 2023

(30) Foreign Application Priority Data
Dec. 30, 2021 (IN) 202141061670

(51) Int. Cl. G06Q 40/04; G06Q 40/06

(52) U.S. Cl. CPC G06Q 40/04; G06Q 40/06

(57) ABSTRACT

The present disclosure proposes a rating system for comparative analysis of tradable securities and method thereof. The system (100) comprises a first selection module (102), a first analysis module (104), a second selection module (106), a second analysis module (108), a processing module (110) and a display module (112). The proposed versatile rating system for comparative analysis of tradable securities enables easy and customized analysis and comparison of different analyses results and thereby aids the investors to take better investment decisions. The proposed rating system concatenates the results of various analyses such as technical analysis and fundamental analysis of securities and displays a comparative analysis to aid in decision making process of the investor. Further, the proposed rating system enables the investors to choose from a wide range of parameters and define a rating system based on their choice.

### PREAMBLE TO THE DESCRIPTION

The following specification particularly describes the invention and the manner in which it is to be performed:

### DESCRIPTION

### Field of the Invention

The present disclosure generally relates to the technical field of security screening, and in specific relates to a versatile rating system for comparative analysis of tradable securities that enables easy and customized analysis and comparison of different analyses results and thereby aids the investors to take better investment decisions.

### Background of the Invention

Computer systems provide powerful analysis tools in business, research, education, government and other fields. One field of interest includes the analysis of financial markets and instruments. Financial markets enable trading of securities such as stocks, bonds, options, commodities, mutual funds, cryptocurrencies and derivatives thereof. Implementation of computer systems in financial markets has been the subject of many types of published techniques including automated and manual techniques. With advancements in the field of financial analysis, these techniques have become more numerous and varied. Often different techniques may work well in some situations, or for a certain period of time, but will fail to provide desirable results in other situations or at other periods of time.

An equity market is a market in which shares of companies are issued and traded, either through exchanges or over-the-counter markets. Also known as the stock market, it is one of the most vital areas of a market economy. It gives companies access to capital to grow their business, and investors a piece of ownership in a company with the potential to realize gains in their investment based on the company's future performance. Following the equity market, there are other similar markets that trade securities such as bonds, mutual funds and cryptocurrencies thereof.

There are various types of investors in the financial markets such as retail investors and institutional investors. Institutional investors include investing organizations which invest on behalf of prospective clients and companies, whereas retail investors include individual investors who invest independently. Out of all the generic terms “screening” refers to a methodology by which a long list of securities is reduced to a smaller list of securities for further analysis by using various parameters as filters. Screening is an essential tool for professional and independent investors since it enables investors to wade through thousands of potential investment choices and obtain a more manageable list of securities for closer analysis.

There are two basic analysis techniques for any security that improve investment decisions of investors such as fundamental analysis and technical analysis. Fundamental analysis of a security is performed by analyzing the parameters which define historical performance and indicate future performance of a security. For instance, when a stock is considered, parameters in balance sheet, profit and loss statement, cash flow statement, shareholding pattern, PE ratio (Price to Equity) and EPS (Earnings per Share) and various other parameters thereof aid in evaluating the stock fundamentally. Fundamental analysis aids the investors analyze the business of the stock and decide about investing for long term. Whereas, technical analysis of a security aids the investor to decide on investing for short term. Technical analysis is performed by considering the historic price and volume movement of the security. There are many algorithms, multiple candlestick patterns, indicators that goes into the technical analysis for a security. A seasoned analyst or investor uses both the information from Fundamental and Technical Analysis to take decisions on a particular security.

In existing technology, a method for equity screening and analysis is known. The method includes the steps of ranking plurality of equity parameters to normalize each equity parameter with respect to each other equity parameter. Investor preferences respecting the weight to be given equity parameters of interest are received and the ranked equity parameters of interest are weighted based upon the received investor preferences to assign each equity a score. The investor selects a scored equity appropriate for the investor preferences. However, the system does not correlate technical analysis and fundamental analysis for the investor to review and compare them together.

Conventionally, investors utilize either fundamental analysis or technical analysis to determine whether to buy or sell financial securities such as stocks. However, it is evident that using combination of fundamental and technical analysis aids to improve the decision making of the investors. But existing systems either display only either one of the analysis results but do not provide comparative results. There exist many systems which combinedly assess the stocks or financial securities but fail to provide a comparative analysis of technical and fundamental analysis techniques.

Therefore, there is a need for a versatile rating system for comparative analysis of tradable securities that enables easy and customized analysis and comparison of different analyses results and thereby aids the investors to take better investment decisions. A system that concatenates the results of various analyses to aid in decision making process of the investor is the need of the hour.

A system that refines the list of securities from a range of hundreds of stocks to tens of stocks to thereby make the investment decisions easier to the investors is required. There is a need for a system that provides comparative analysis of various analysis techniques for financial securities to enable the investor to choose the right stocks by comparison. There is a need for a system that enables an investor to compare a wide range of securities side by side irrespective of region and type of security.

### Objectives of the Invention

The primary objective of the invention is to provide a versatile rating system for comparative analysis of tradable securities that enables easy and customized analysis and comparison of different analyses results and thereby aids the investors to take better investment decisions.

The other objective of the invention is to provide a system that concatenates the results of various analyses such as technical analysis and fundamental analysis of securities such as stocks, mutual funds, bonds, cryptocurrencies and displays a comparative analysis to aid in decision making process of the investor.

Another objective of the invention is to provide a system that enables comparison of multiple securities irrespective of region of trading and type of security using similar analysis techniques.

Yet another objective of the invention is to provide a rating system that enables the investors to choose from a wide range of parameters and define a rating system based on their choice.

Further objective of the invention is to provide a system that refines the list of securities from a range of hundreds of securities to tens of securities to thereby make the investment decisions easier to the investors.

The other objective of the invention is to provide a system that compares either the ratings or a combination of at least one parameter and a star rating of both technical and fundamental analyses of securities to enable the investor to choose the right securities by comparison.

Another objective of the invention is to provide a system that acts as a screening tool for tradable securities such as stocks, mutual funds, cryptocurrencies, and bonds thereof.

### SUMMARY OF THE INVENTION

The present disclosure proposes a rating system for comparative analysis of tradable securities and method thereof. The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

In order to overcome the above deficiencies of the prior art, the present disclosure is to solve the technical problem to provide a versatile rating system for comparative analysis of tradable securities that enables easy and customized analysis and comparison of different analyses results and thereby aids the investors to take better investment decisions.

According to an aspect, the invention provides a rating system for comparative analysis of tradable securities and method thereof. The system comprises a first selection module, a first analysis module, a second selection module, a second analysis module, a processing module and a display module. The system is a versatile rating system that enables easy and customized analysis and comparison of different analyses results of tradable securities and thereby aids the investors in taking better investment decisions in financial markets. The proposed system utilizes either a web application or a mobile application or a third party application that is accessible through a communication device including either a laptop or personal computer or a smartphone or a tablet thereof.

The first selection module is configured to enable an investor to choose a region, a first type of security and a first analysis technique. The first analysis module is configured to provide plurality of primary parameters to be selected by the investor based on the first type of security and the first analysis technique and wherein the first analysis module is configured to enable the investor to input plurality of primary rating criteria that correspond to the selected plurality of primary parameters.

The second selection module is configured to enable the investor to choose a second type of security and a second analysis technique. In specific, the first type of security and the second type of security include either equities or bonds or mutual funds thereof. The first analysis technique and the second analysis technique include fundamental analysis, technical analysis or other similar analysis techniques thereof.

Further, the second selection module is configured to automatically select a complementary analysis technique to the first analysis technique as the second analysis technique based on the first analysis technique selected by the investor if the first type of security and the second type of security are the same and only a single region is selected.

The second analysis module is configured to provide plurality of secondary parameters to be selected by the investor. The second analysis module is configured to receive plurality of secondary rating criteria input by the investor that correspond to the selected plurality of secondary parameters. In specific, the plurality of primary rating criteria and the plurality of secondary rating criteria include plurality of conditions that correspond to the plurality of primary parameters and the plurality of secondary parameters respectively and wherein the plurality of conditions are defined by the investor. Further, the secondary rating criteria is optional and the investor is enabled to choose either multiple parameters or at least one parameter related to the second analysis technique.

The processing module is configured to process the selected plurality of primary parameters and the plurality of primary rating criteria to obtain a primary list of tradable securities with plurality of primary ratings and process the selected plurality of secondary parameters and the plurality of secondary rating criteria to obtain a secondary list of tradable securities with plurality of secondary ratings.

In specific, the plurality of primary ratings and the plurality of secondary ratings include either star ratings or point-based ratings or absolute category ratings or graphic ratings thereof. The display module is configured to receive the primary ratings and the secondary ratings of the tradable securities and display a combined list of tradable securities to the investor with the primary ratings and the secondary ratings for comparison.

According to another aspect, the invention provides a method for comparative analysis of tradable securities. The method includes the steps comprising of enabling an investor to choose a region, a first type of security and a first analysis technique. Then, the plurality of primary parameters to be selected by the investor based on the first type of security and the first analysis technique are provided to the investor.

Later, the investor is enabled to input plurality of primary rating criteria that correspond to the selected plurality of primary parameters. Then, the system enables the investor to choose a second type of security and a second analysis technique. Next, plurality of secondary parameters to be selected by the investor are provided based on the selected plurality of secondary parameters. Later, the investor is enabled to input plurality of secondary rating criteria input by the investor that correspond to the selected plurality of secondary parameters.

The selected plurality of primary parameters, the plurality of primary rating criteria, the selected plurality of secondary parameters and the plurality of secondary rating criteria are processed to obtain plurality of primary ratings of the primary list of tradable securities and secondary ratings of the secondary list of tradable securities. Finally, the primary ratings and the secondary ratings of the tradable securities are received from a processing module to display a combined list of tradable securities with the primary ratings and the secondary ratings for comparison on a display module.

Further, objects and advantages of the present invention will be apparent from a study of the following portion of the specification, the claims, and the attached drawings.

### DETAILED DESCRIPTION OF DRAWINGS

The accompanying drawings, which are incorporated in and constitute a part of the specification, illustrate an embodiment of the invention, and, together with the description, explain the principles of the invention.

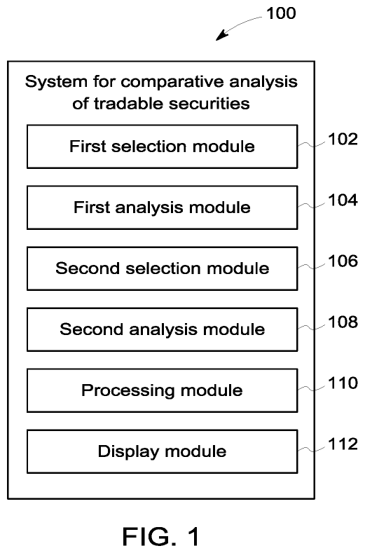

FIG. 1 illustrates an exemplary block diagram of a rating system for comparative analysis of tradable securities in accordance to an exemplary embodiment of the invention.

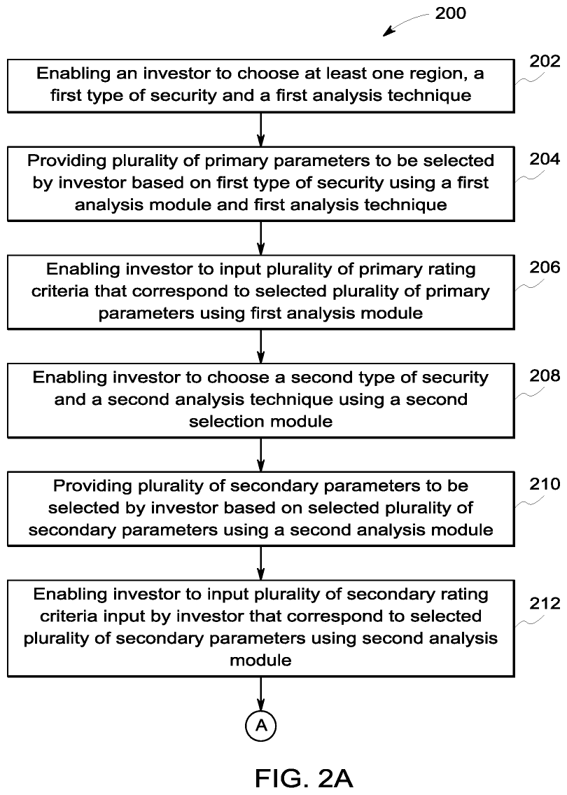

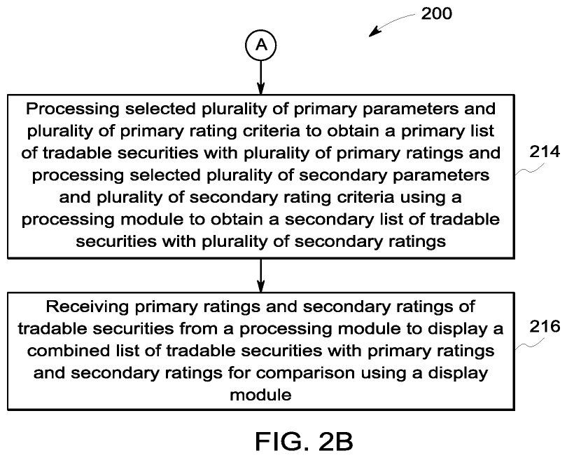

FIG. 2A and FIG. 2B illustrate an exemplary method for comparative analysis of tradable securities in accordance to another exemplary embodiment of the invention.

### DETAILED INVENTION DISCLOSURE

Various embodiments of the present invention will be described in reference to the accompanying drawings. Wherever possible, same or similar reference numerals are used in the drawings and the description to refer to the same or like parts or steps.

The present disclosure has been made with a view towards solving the problem with the prior art described above, and it is an object of the present invention to provide a versatile rating system for comparative analysis of tradable securities that enables easy and customized analysis and comparison of different analyses results and thereby aids the investors to make better investment decisions.

According to an exemplary embodiment of the invention, FIG. 1 refers to an exemplary rating system 100 for comparative analysis of tradable securities and method thereof. The system 100 comprises a first selection module 102, a first analysis module 104, a second selection module 106, a second analysis module 108, a processing module 110 and a display module 112. The proposed system 100 is a versatile rating system that enables easy and customized analysis and comparison of different analyses results and thereby aids the investors to make better investment decisions in financial markets. The proposed system 100 utilizes either a web or a mobile application or a third party application that is accessible through a communication device including either a laptop or personal computer or a smartphone or a tablet thereof.

The first selection module 102 is configured to enable an investor to choose a region, a first type of security and a first analysis technique. The first analysis module 104 is configured to provide plurality of primary parameters to be selected by the investor based on the first type of security and the first analysis technique. The first analysis module 104 is configured to enable the investor to input plurality of primary rating criteria that correspond to the selected plurality of primary parameters.

The second selection module 106 is configured to enable the investor to choose a second type of security and a second analysis technique. In specific, the first type of security and the second type of security include either equities or bonds or mutual funds or cryptocurrencies thereof. Further, the region includes any specific country or continent or other regions that are classified based on financial markets. In specific, the regions selected by the investor may include different countries or continents thereof. The first analysis technique and the second analysis technique include fundamental analysis, technical analysis or other similar analysis techniques such as sentimental analysis thereof.

Further, the second selection module 106 is configured to automatically select an analysis technique that is complementary to the first analysis technique as the second analysis technique based on the first analysis technique selected by the investor if the first type of security and the second type of security are same and a single region is selected in the first selection module.

For instance, if the investor selects technical analysis in the first selection module and selects only single region and the same type of security in the second selection module to that of the first selection module, then the second analysis module automatically selects the fundamental analysis, to thereby enable the investor to compare both analysis techniques side by side. Whereas if the type of securities selected in the first selection module and the second selection module are same, then the second selection module 106 automatically selects the secondary analysis technique same to that of the first selection module.

The second analysis module 108 is configured to provide plurality of secondary parameters to be selected by the investor based on the selected plurality of secondary parameters. The second analysis module 108 is configured to receive plurality of secondary rating criteria input by the investor that correspond to the selected plurality of secondary parameters.

In specific, the plurality of primary rating criteria and the plurality of secondary rating criteria include plurality of conditions that correspond to the plurality of primary parameters and the plurality of secondary parameters respectively and wherein the plurality of conditions are defined by the investor. Further, the secondary rating criteria is optional and the investor is enabled to choose either multiple parameters or at least one parameter related to the second analysis technique.

In specific, if technical analysis is chosen as the first analysis technique, then the primary parameters include historic price, volume movement, moving average convergence divergence, relative strength index and stochastic oscillator thereof which can be selected by the investor for technical analysis. Further, the parameters for technical analysis may comprise other parameters such as the formation of various candle patterns comprising bullish engulfing, bearish engulfing, shooting star pattern, hammer candle and various other patterns that are detectable by various algorithms thereof.

Similarly, when the investor chooses the fundamental analysis, then the parameters comprise of at least one parameter in balance sheet, profit and loss statement, cash flow statement, shareholding pattern, PE ratio (Price to Earnings), EPS (Earnings per Share), return on equity (ROE) thereof that can be selected by the investor. The investor is provided with a choice to select any analysis technique as the first analysis technique and as the second analysis technique, based on which the parameters are displayed to the investor for selection. Once the parameters are chosen by the investor, the investor inputs the rating criteria for the corresponding parameters chosen.

The processing module 110 is configured to process the selected plurality of primary parameters and the plurality of primary rating criteria to obtain a primary list of tradable securities with plurality of primary ratings and process the selected plurality of secondary parameters and the plurality of secondary rating criteria to obtain a secondary list of tradable securities with plurality of secondary ratings.

The primary list of tradable securities and the secondary list of tradable securities are obtained from various databases of different financial markets. In specific, the plurality of primary ratings and the plurality of secondary ratings include either star ratings or point-based ratings or absolute category ratings or graphic ratings thereof.

For instance, when the technical analysis is chosen as the first analysis the primary rating criteria include specific conditions such as a certain percentage of reduction or increase in price in the last few weeks, price trading near 52 week low or trading at 52 week high and other similar parameters thereof. The primary rating is given highest to the stock that matches the primary rating criteria to the highest level and the other stocks are given a rating in the decreasing order based on the level of matching the primary rating criteria. The secondary rating is also given similar to that of the primary rating criteria.

The display module 112 is configured to receive the primary ratings and the secondary ratings of the tradable securities and display a combined list of tradable securities to the investor with the primary ratings and the secondary ratings for comparison. The columns depicting the rating are interchangeable as per the preference of the investor for sorting purposes.

In specific, the combined list of tradable securities is obtained by the display module by shortlisting the primary list and the secondary list of tradable securities based on the plurality of primary parameters and the plurality of secondary parameters selected by the investor, where the type of security selected in both the selection modules is the same. When the type of security is different in both the selection modules, then the combined list is just a mere added and sorted list of the primary list of tradable securities and the secondary list of tradable securities based on the primary rating criteria and the secondary rating criteria defined by the investor that aids in the comparison of different types of securities.

For instance, when the plurality of primary parameters includes mid-cap stocks that are not very expensive and wherein the primary list is obtained by considering the mid-cap stocks, whereas the secondary list comprises all the mid-cap stocks that are moderately costly and whose price is increased about at least 15% in the last 6 months. This type of shortlisting the stocks based on multiple analyses reduces the number of stocks for the investor to choose from.

In an embodiment, the rating system is utilized for rating equities (stocks) in an equity market. For instance, when an investor wants to invest in mid-cap stocks that are not very expensive and the stock price is at least 15% up from the last 6 months. Such combination requires sound data from both the fundamental analysis and technical analysis. Here, the investor chooses the technical analysis as the first analysis technique and the fundamental analysis as the second analysis technique.

The proposed system enables the investor to choose the technical analysis parameter i.e., the stock price is increased by about at least 15% in the last 6 months. In specific, the investor needs to enter percentage of increase in price of stock and the corresponding time period in which the stock price is increased. Once the investor chooses this parameter, the system provides a primary list of all the stocks whose price is increased by about at least 15% in the last 6 months.

Later, the investor inputs the rating criteria into the system such as 5-star rated for stocks with price up by at least 40%, 4-star rating for stocks with price up by 30%-40%, 3-star rating for stocks with price up by 25%-30%, 2-star rating for stocks with price up by 20%-25% and a 1-star rating for stocks with price up by 15%-20%. Here, the allocation of each star rating is determined by rating criteria input the investor. Then, the investor inputs the fundamental analysis parameters i.e., mid-cap stocks that are not very expensive. The specific parameters include market capitalization between 2,000-50,000 crores that represent mid-cap stocks and stocks with a price to earnings ratio less than 30 represent stocks that are not very expensive.

Similar to primary rating criteria, the investor inputs secondary criteria such as 5-star rating for stocks with market-cap between 5,000-10,000 crores and 10<PE<20, 4-star rating for stocks with market-cap between 10,000-20,000 crores and 10<PE<25, 3-star rating for stocks with market-cap between 20,000-25,000 crores and 15<PE<25, 2-star rating for stocks with market-cap between 25,000-35,000 crores and 20<PE<25 and 1-star rating for stocks with market-cap between 35,000-50,000 crores and 20<PE<30. Once the primary and secondary parameters and the primary and secondary rating criteria are input by the investor, the system shortlists the stocks using the parameters and the rating criteria.

The system provides the investor with 3 types of choices to compare the fundamental and technical analyses of the stocks. The first type includes a comparison of primary rating and secondary rating as shown in the table below.

TABLE 1

| | Name of the | Fundamental analysis | Technical analysis |
|---|---|---|---|
| S. No | company | 5-star rating | 5-star rating |
| 1 | ABC Ltd | 5 | 3 |
| 2 | DEF Ltd | 4 | 1 |
| 3 | GHE Ltd | 2 | 5 |

The comparative ratings of the primary and secondary ratings enable the investor to choose the stocks easily after selecting the required parameters. From the above table, it is evident that ABC Ltd stock is the best choice for the investor based on the fundamental and technical analysis parameters.

The second type of choice includes directly comparing at least one parameter of technical analysis with rating obtained from fundamental analysis as shown in the table below.

TABLE 2

| | | Companies price | |
|---|---|---|---|
| | Name of the | increase sorted by | Fundamental analysis |
| S. No | company | % - Technical Analysis | 5-star rating |
| 1 | ABA Ltd | 50% | 2 |
| 2 | TYU Ltd | 47% | 5 |
| 3 | MNE Ltd | 46.% | 3 |
| 4 | OIU Ltd | 45% | 1 |

From Table 2, the stocks are shortlisted by considering price increase for the past 6 months (Technical Analysis). Then the results are combined with the ratings of Fundamental analysis. From the above table, despite ABA Ltd where the price increase is 50%, it is better to invest in TYU Ltd where the price increase is 47% because the star rating from the fundamental analysis is 5.

Similarly, the third type of choice includes directly comparing at least one parameter of fundamental analysis with ratings of technical analysis as shown in table 3.

TABLE 3

| | Name of the | Mid-cap companies | Technical analysis |
|---|---|---|---|
| S. No | company | sorted by PE | 5-star rating |
| 1 | HET Ltd | 15 | 2 |
| 2 | TYU Ltd | 18 | 5 |
| 3 | OOI Ltd | 20 | 3 |
| 4 | PUE Ltd | 25 | 4 |

In the above table, the mid-cap companies are sorted by their PE (Fundamental Analysis). Then the results are combined with the ratings of technical analysis. From the above table, despite HET Ltd where PE is 15, it is better to invest in TYU Ltd where PE is 18 because the star rating from the technical analysis is 5.

Similarly, the system is applicable to compare equities of different markets such as the comparison of NIFTY and NASDAQ and other equity markets thereof by selecting different regions in the first and second selection modules. Further, the system enables the investor to compare different types of securities such as comparing stocks and cryptocurrencies or comparing stocks and mutual funds or comparing stocks and bonds and other possible combinations which include either similar types of securities or different types of securities and also combinations including different regions.

Also, the system enables comparison of tradable securities across various rules of classification based on the region or type of financial market or type of currency thereof to thereby bring all the data in preferred classifications such as preferred currency or type of classification or type of financial rules thereof. For instance, stocks in a specific market are classified based on a specific range of market capitalization where the range varies from region to region. The system classifies the tradable securities based on the criteria according to the choice of the investor which reduces the complexity in comparison of securities of various classifications and currencies thereof.

According to another exemplary embodiment, FIG. 2A and FIG. 2B refer to a method 200 for comparative analysis of tradable securities. The method 200 includes the steps comprising of enabling an investor to choose a region, a first type of security and a first analysis technique at step 202. Then at step 204, the plurality of primary parameters to be selected by the investor based on the first type of security and the first analysis technique are provided to the investor to obtain a primary list of tradable securities based on the selected plurality of primary parameters.

Later at step 206, the investor is enabled to input plurality of primary rating criteria that correspond to the selected plurality of primary parameters. Then at step 208, the system enables the investor to choose a second type of security and a second analysis technique. Next, the plurality of secondary parameters to be selected by the investor are provided based on the selected plurality of secondary parameters at step 210. Later, the investor is enabled to input plurality of secondary rating criteria input by the investor that correspond to the selected plurality of secondary parameters at step 212.

The selected plurality of primary parameters, the plurality of primary rating criteria, the selected plurality of secondary parameters and the plurality of secondary rating criteria are processed to obtain a primary list of tradable securities with plurality of primary ratings of and a secondary list of tradable securities with plurality of secondary ratings at step 214. Finally at step 216, the primary ratings and the secondary ratings of the tradable securities are received from a processing module to display a combined list of tradable securities with the primary ratings and the secondary ratings for comparison. The final output displayed by the system to the investor enables the investor interchange the columns that depict the list of the tradable securities based on the analysis technique.

In an embodiment, the system is applicable to mutual funds where the parameters of primary analysis include analysis of the fund manager, Asset Management Company (AMC), expense ratio, minimum investment amount, turnover and past returns achieved by the fund manager or AMC thereof, when fundamental analysis is chosen as primary analysis technique. Similarly, secondary analysis parameters may include current net asset value (NAV), trading volumes, support, resistance, and moving averages thereof when technical analysis is chosen as secondary analysis technique.

In another embodiment, the system is applicable to cryptocurrencies where the parameters for fundamental analysis may comprise market capitalization, white paper, financial metrics, liquidity thereof. The technical analysis parameters of the cryptocurrencies are similar to that of the stocks or equities.

Numerous advantages of the present disclosure may be apparent from the discussion above. In accordance with the present disclosure, a versatile rating system for comparative analysis of tradable securities is disclosed that enables easy and customized analysis and comparison of different analyses results and thereby aids the investors to make better investment decisions. The proposed rating system concatenates the results of various analyses such as technical analysis and fundamental analysis of stocks and displays a comparative analysis to aid in the decision-making process of the investor. Further, the proposed rating system enables the investors to choose from a wide range of parameters and define a rating system based on their choice.

The rating system refines the list of stocks from a range of hundreds of stocks to tens of stocks to thereby make the investment decisions easier for the investors. The proposed system compares either the ratings or a combination of at least one parameter and a star rating of both technical and fundamental analyses of stocks to enable the investor to choose the right stocks by comparison. The system acts as a screening tool for tradable securities such as stocks, mutual funds, and bonds thereof.

The proposed system may utilize any national or global database to extract the list of stocks and their relevant data for analysis. Further, the system may also be applied to cryptocurrencies to analyze fundamentals and technical aspects and aid in investment decisions. The system may utilize existing sorting and filtering algorithms to shortlist the stocks or mutual funds or bonds or cryptocurrencies thereof. The proposed system may further utilize artificial intelligence or machine learning techniques to accurately identify the securities.

The system may eliminate tradable securities that match the least to the rating criteria given by the investor by assigning them a least rating thereof which eliminates all the unwanted/unnecessary/not-interested securities that further aids in bringing down the size of the list. For instance, the least rating may include a 0-star rating in star ratings, 0 points in point-based ratings thereof. Further, the system enables the user to choose multiple regions in the first selection module, which enables the user to compare securities of different countries or continents thereof, which expands the scope of comparison and thereby enhances the investment decision process of the investor.

It will readily be apparent that numerous modifications and alterations can be made to the processes described in the foregoing examples without departing from the principles underlying the invention, and all such modifications and alterations are intended to be embraced by this application.

I claim:

1. A system for comparative analysis of tradable securities, comprising:
a first selection module configured to enable an investor to choose at least one region, a first type of security and a first analysis technique;
a first analysis module configured to provide plurality of primary parameters to be selected by said investor based on said first type of security and said first analysis technique and wherein said first analysis module is configured to enable said investor to input plurality of primary rating criteria that correspond to said selected plurality of primary parameters;
a second selection module configured to enable said investor to choose a second type of security and a second analysis technique;
a second analysis module configured to provide plurality of secondary parameters to be selected by said investor and configured to receive plurality of secondary rating criteria input by said investor that correspond to said selected plurality of secondary parameters;
a processing module configured to process said selected plurality of primary parameters and said plurality of primary rating criteria to obtain at least one primary list of tradable securities with plurality of primary ratings and process said selected plurality of secondary parameters and said plurality of secondary rating criteria to obtain at least one secondary list of tradable securities with plurality of secondary ratings;
a display module configured to receive said plurality of primary ratings and said plurality of secondary ratings of said tradable securities and display a combined list of tradable securities to the investor with said primary ratings and said secondary ratings for comparison,
wherein said system is a versatile rating system that enables easy and customized analysis and comparison of different analyses results of tradable securities and thereby aids the investors to take better investment decisions in financial markets.

2. The system for comparative analysis of tradable securities as claimed in claim 1, wherein said first type of security and said second type of security include either equities or bonds or mutual funds thereof.

3. The system for comparative analysis of tradable securities as claimed in claim 1, wherein said first analysis technique and said second analysis technique include fundamental analysis, technical analysis or other similar analysis techniques thereof.

4. The system for comparative analysis of tradable securities as claimed in claim 1, wherein said second selection module is configured to automatically select a complementary analysis technique to said first analysis technique as said second analysis technique based on said first analysis technique selected by said investor if said first type of security and said second type of security are same and only one region is selected.

5. The system for comparative analysis of tradable securities as claimed in claim 1, wherein said plurality of primary rating criteria and said plurality of secondary rating criteria include plurality of conditions that correspond to said plurality of primary parameters and said plurality of secondary parameters respectively and wherein said plurality of conditions are defined by said investor.

6. The system for comparative analysis of tradable securities as claimed in claim 1, wherein said system utilizes either a web application or a mobile application or third-party application that is accessible through a communication device including either a laptop or personal computer or a smartphone or a tablet thereof.

7. The system for comparative analysis of tradable securities as claimed in claim 1, wherein said plurality of primary ratings and said plurality of secondary ratings include either star ratings or point based ratings or absolute category ratings or graphic ratings thereof.

8. The system for comparative analysis of tradable securities as claimed in claim 1, wherein said primary list of tradable securities and said secondary list of tradable securities are merged using said display module to obtain said combined list of tradable securities wherein the columns are interchangeable in said combined list based on the choice of the investor.

9. The system for comparative analysis of tradable securities as claimed in claim 1, wherein said secondary rating criteria is optional and said investor is enabled to choose either multiple parameters to obtain said plurality of ratings or at least one parameter related to said second analysis technique.

10. A method for comparative analysis of tradable securities, comprising:
enabling an investor to choose at least one region, a first type of security and a first analysis technique using a first selection module;
providing plurality of primary parameters to be selected by said investor based on said first type of security using a first analysis module and said first analysis technique;
enabling said investor to input plurality of primary rating criteria that correspond to said selected plurality of primary parameters using said first analysis module;
enabling said investor to choose a second type of security and a second analysis technique using a second selection module;
providing plurality of secondary parameters to be selected by said investor based on said selected plurality of secondary parameters using a second analysis module;
enabling said investor to input plurality of secondary rating criteria input by said investor that correspond to said selected plurality of secondary parameters using said second analysis module;
processing said selected plurality of primary parameters and said plurality of primary rating criteria to obtain a primary list of tradable securities with plurality of primary ratings and processing said selected plurality of secondary parameters and said plurality of secondary rating criteria using a processing module to obtain a secondary list of tradable securities with plurality of secondary ratings, and
receiving said primary ratings and said secondary ratings of said tradable securities from a processing module to display a combined list of tradable securities with said primary ratings and said secondary ratings for comparison using a display module.
